(19) United States
(12) Patent Application Publication
(10) Pub. No.: US 2012/0302107 A1
(43) Pub. Date: Nov. 29, 2012

(54) METHOD FOR PRODUCING AN ELECTRICALLY CONDUCTIVE CONNECTION

(75) Inventor: Reiner Ramsayer, Schwieberdingen (DE)

(73) Assignee: ROBERT BOSCH GMBH, Stuttgart (DE)

(21) Appl. No.: 13/513,641

(22) PCT Filed: Oct. 13, 2010
(86) PCT No.: PCT/EP2010/065296

§ 371 Date: Aug. 8, 2012

(30) Foreign Application Priority Data
Dec. 4, 2009 (DE) 10 2009 047 490.0

(51) Int. Cl. H01R 4/28; H01R 43/16

(52) U.S. Cl. 439/761; 29/874

(57) ABSTRACT

Method for producing an electrically conductive connection, in particular between a contact pin (30, 32) and a cross connection link (34) on battery cells (10) in a battery pack (12). The contact pins (30, 32) are produced from a material A and the cross connection links (34) are produced from a material B, which is different than material A. The contact pins (30) and (32) can also be produced from the material B and the lug-shaped cross connection links (34) can also be produced from material A. Openings (35) or slot-shaped opening geometries (72) are produced in the cross connection link (34). A cohesive connection (52) between the contact pins (30, 32) and the lug-shaped cross connection links (34) is produced by laser welding.

### BACKGROUND OF THE INVENTION

WO 2006/016441 A1 relates to a battery arrangement in which thin metal plates are spot-welded. At the metal plates embodied in thin fashion, different melting points are produced by laser welding, wherein the metallic material from which the metal plates are produced has a relatively low melting point. The metallic plates are produced from aluminum or from copper. The metallic plates form an arrangement substantially in a laminar structure. They are arranged in stack form and form a battery arrangement as a stack.

WO 2007/112116 A2 relates to a battery module for hybrid vehicles. The battery is a lithium ion or nickel metal hydride battery. Each of the battery cells of the battery module is electrically connected to one another, wherein this connection is embodied as a welding connection. The welding connection can be produced by resistance welding, laser welding or ultrasonic welding. The individual battery cells are incorporated within an insulating frame. The insulating frame holds the individual cells at a relative distance from one another.

JP 2008-226519 A relates to a battery arrangement having a number of parallelepipedal cells. The number of cells embodied in parallelepipedal fashion are equipped on a positive electrode terminal and a negative electrode terminal, wherein the individual cells are connected in series. The positive electrode terminal of one cell is respectively connected to the negative electrode terminal at the other cell by means of laser welding. Each of the battery cells comprises a safety valve arranged on the opposite side of the battery cell.

In the region of the contact-connection of batteries, thus lithium ion batteries, for example, that are used nowadays in hybrid vehicles, high currents have to be transmitted. This requires firstly high cross sections of the conduction carriers and secondly, for use in an automobile, a very high reliability, a high mechanical strength and a permanently stable connection technology that withstands vibrations.

In the case of the contact-connection of battery cells in a stack arrangement, the anodes and respectively the cathodes of the individual cells have to be connected. In this case, one of the terminals, typically in the case of a lithium ion battery, is produced from an aluminum material and the other terminal generally comprises a copper material. These materials are both distinguished by a high electrical and thermal conductivity.

The individual battery cells of the battery pack are contact-connected to one another and connected to form a stack by means of aluminum or copper sheet-metal strips, which are also designated as connectors. In order to achieve the best possible contact resistances at the contact locations, cohesive connection techniques or joining techniques are preferred.

However, since the individual battery cells of the battery pack must not become too hot during the joining process, which might induce damage to the cell or the so-called “thermal runaway”, the heat input during the cohesive joining process is to be minimized as far as possible.

Nowadays, the cells are screwed together, for example, for lack of suitable joining methods. However, this connection technique is not permanently stable to a sufficient extent and the contact resistances remain too high, which can in turn lead to losses and/or to undesirable heating of the contact locations.

Independently of whether the connector is embodied as an aluminum or copper strip, the case can occur in which a type of dissimilar connection of aluminum/copper has to be produced.

### SUMMARY OF THE INVENTION

The invention proposes a contact-connection technology between type-identical combinations, i.e. aluminum/aluminum or copper/copper, and type-dissimilar combinations, i.e. aluminum/copper. The contact-connection is effected by means of laser welding, wherein a cross-connector of the cells is connected by means of a laser welding method, and a welding-suitable construction of the respective connection location is prepared. A process-reliable producibility of a connection location composed of a type-dissimilar combination, aluminum/copper in the present context, is possible as a result of the solution proposed according to the invention.

The type-identical combination of aluminum/aluminum or copper/copper is simpler to control by way of the cohesive joining method than the fusion welding of type-dissimilar combinations aluminum/copper on account of the intermetallic phase that forms, and owing to the different coefficients of thermal expansion of aluminum and copper.

In order to avoid the formation of intermetallic phases it is absolutely necessary to melt precisely defined proportions by mass of the two material aluminum and copper in the melting bath. This is preferably possible by means of the laser method, which can be controlled very precisely and introduces locally delimited heat.

In a first embodiment variant of the solution proposed according to the invention, a pin of preferably round geometry composed of a material A is inserted into a connector produced from a material B and is locally melted by means of laser radiation being coupled in. In this case, the material of the connector, i.e. the material B, is preferably plated with the material A of the pin.

Preferably, the pin material used is the material having the lower melting point, usually aluminum, wherein the connector material is the material having the higher melting point, generally copper. Aluminum roll-clad copper materials are known from the prior art. Furthermore, the aluminum coating can also be applied locally to the copper connection.

The connection of a pin produced from copper to a connector composed of aluminum is more critical, since the heat dissipation and the thermal properties with regard to the melting point of aluminum and copper are less favorable.

This technique for the connection of two materials having greatly different melting points is the subject of DE 103 59 564 B4.

If the hole in the connector is coated with the material A, i.e. the pin material, internally in the hole on the inner side of an opening, thus of a hole, for example, then the pin can also be countersunk in the hole. In this method, the basic material of the connector is not melted or is only insignificantly incipiently melted. The connection is effected by the incipient melting of the pin material onto the connector coating on the inner side of the opening through which the pin extends.

In a further embodiment variant of the solution proposed according to the invention, a pin welded-in fitting is effected by the pin material A and the connector material B being melted. In this case, care should be taken to ensure that the mixing ratios of aluminum/copper in the melting bath result in an intermixing which does not produce any cracks or defects. It is advantageous in the case of this welding arrangement if a type-identical connection is produced, i.e. at a different contact side of the connector, which is then to be connected type-identically to the next cell. Advantageous configurations of the joining geometry are described below:

It is advantageously possible to produce a welding connection which has a ring seam or constitutes a segmented seam in conjunction with a rectangular cross section. The segmented seam has the advantage that when cracks occur in the seam, for example owing to inadequate intermixing in the melting bath, or on account of other process disturbances, the cracks can lead only to the failure of one segment, and the other segments are still available for current transmission and for ensuring strength.

In order to compensate for tolerances, it may be expedient not to connect the cross-connectors used to the pin by means of a hole, but rather to choose a slot geometry. This compensates for length tolerances and is not mechanically overdetermined.

### BRIEF DESCRIPTION OF THE DRAWINGS

The invention is described in greater detail below with reference to the drawing.

In the figures:

FIG. 1 shows embodiments of cross-connections between individual battery cells of a battery pack by means of screw joints,

FIG. 2 shows the basic schematic diagram of the solution proposed according to the invention,

FIG. 3 a first embodiment variant of the solution proposed according to the invention with a contact pin produced from a material A and a cross-connector produced from a material B, which is different than said material A, with a through opening,

FIG. 4 shows a remelting of the cross-connector in the head region of the contact pin and a resulting contact zone,

FIGS. 5.1 to 5.3 show embodiment variants of cohesive connections between cross-connector and contact pin,

FIGS. 5.4 to 5.7 show embodiment variants of cohesive connections, in particular welding seams as a ring seam, segmented seam or U-seam,

FIGS. 6.1 to 6.3 show embodiment variants of contact connections between contact pin and a cross-connector having a slotted opening for compensating for length tolerances,

FIGS. 6.4 to 6.6 show embodiment variants of cohesive connections between a cross-connector having a slotted opening geometry and a contact pin with a spot weld, segmented seam weld and O-seam weld.

### DETAILED DESCRIPTION

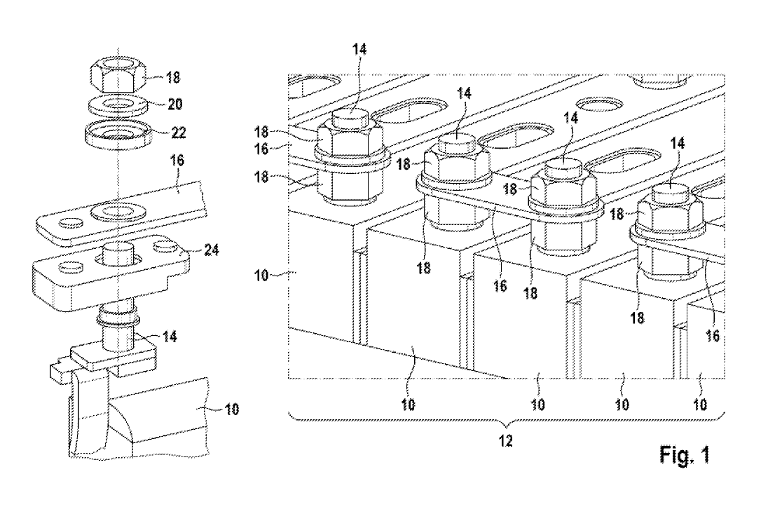

The illustration in accordance with FIG. 1 reveals that a number of battery cells 10 are connected together to form a battery pack or battery module 12. Each of the battery cells 10 comprises a terminal pin 14. The terminal pins 14 of two battery cells are in each case screwed together by means of a strap 16 serving as a cross-connector. The screwing-together is effected by means of nuts 18 which are screwed onto external threads of the terminal pins 14 of the individual battery cells 10 and bear on the straps 16 by means of a washer 20. The exploded illustration likewise illustrated in FIG. 1 shows that firstly a shoe 24 is applied to the terminal pin 14, said shoe in turn supporting the strap 16 serving as a cross-connector. A collar 22 is on the top side of the strap 16, said collar embracing the washer 20 that is screwed by means of the nut 18. The screw joint illustrated in FIG. 1 has various disadvantages, however. Firstly, this connection technique is not permanently stable to a sufficient extent, i.e. the screws can become loose on account of the vibrations occurring during operation, even if they have been firmly tightened in relation to one another. Furthermore, one disadvantage of this solution is the high contact resistances established, which can lead to losses and/or to undesirable heating in the region of the contact locations. The materials, in particular copper, relax over time. This means that the prestress force of a screw decreases over time, as a result of which the contact resistance deteriorates considerably.

### Embodiment Variants

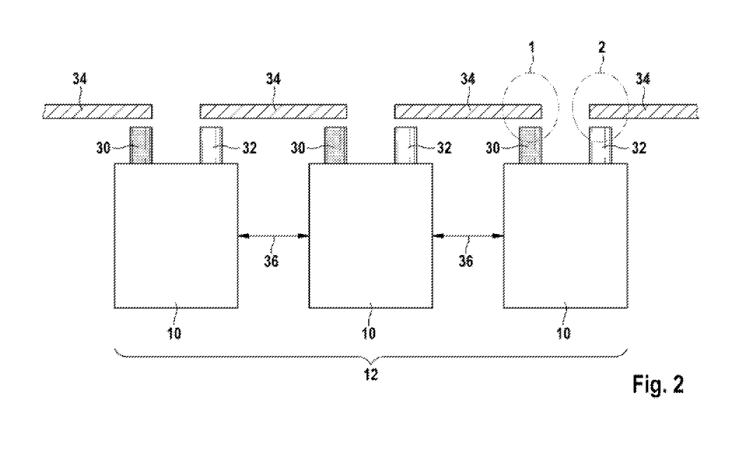

The illustration in accordance with FIG. 2 reveals in schematic illustration an interconnection structure of battery cells 10 to form a battery pack or battery module 12.

Each of battery cells 10 comprises a first contact pin 30, which is produced for example from a material A, thus for example aluminum, and a further, second contact pin 32, which is produced from a material B, thus for example from copper or a copper alloy. The material of a cross-connector 34 embodied in strap-type fashion can be chosen freely. Preferably, the material of the cross-connector 34 is aluminum or copper, since high electrical conductivities are required in the present context.

The method proposed according to the invention can be used to produce cohesive joints, firstly between the first contact pin 30 and the cross-connector 34 and secondly between the cross-connector 34 and the second contact pin 32 of an adjacent battery cell 10. In the method proposed according to the invention, cohesive joints are provided for type-identical combinations, for example an aluminum/aluminum pairing between cross-connector 34 and first or second contact pin 30 or 32, or for a further type-identical combination, thus for example copper-copper, for the case where the first contact pin 30 and the second contact pin 32 and the cross-connector 34 are produced from copper. The method proposed according to the invention also provides, alongside the type-identical combinations outlined above, at the cohesive joints that form, a contact-connection technology wherein the cross-connector 34 of the individual battery cells 10 is connected together by laser welding, and a welding-suitable construction of the cohesive joints established, in order to produce a type-dissimilar material combination, such as between aluminum and copper, for example, in a process-reliable manner.

The fusion welding of a type-dissimilar combination, i.e. of a material combination of aluminum and copper, is extremely critical by virtue of the formation of intermetallic phases and owing to the different coefficients of thermal expansion of aluminum and copper. By contrast, type-identical combinations such as the combinations aluminum/aluminum or copper/copper mentioned above can be controlled significantly more simply in terms of welding technology.

In an advantageous configuration of the concept underlying the invention, in order to avoid intermetallic phases precisely defined proportions by mass of the two materials, i.e. of aluminum and copper, are melted in the melting bath. By virtue of the size of the focus and the position of the focus of the laser relative to the joining zone, this is possible to bring about a mixing of the two joining partners within the melting bath in a targeted manner. By means of a targeted choice of the parameters with which the laser is operated, thus for example the laser power, focus or a temporal beam modulation of the laser beam or oscillating or circulating thereof, which can be equated with a spatial beam modulation, it is additionally possible to influence the flow within the melting bath. What can thereby be achieved is that within the melting bath the two melts, thus for example copper and aluminum, mix particularly well, i.e. homogenize or mix into one another only to a very small extent. The parameters with regard to the circulation in the melting bath are set depending on the geometry of the alloys used and the feed-in depth or the feed-in width at the component. A mixing ratio in the range of Cu from 0% to 53%, remainder aluminum, or Cu from 91% to 100%, remainder aluminum is particularly advantageous. Through a suitable choice of the copper alloy or of the aluminum alloy, it is possible to further stabilize the microstructure in the melting zone, such that intermetallic phases can be at least considerably reduced and remain completely excluded in the ideal case. The cohesive contact-connection is preferably produced by the laser welding method, which can be controlled very precisely and allows locally delimited heat inputs that do not adversely affect the battery cells. It is evident from the basic schematic diagram in accordance with FIG. 2 that there is a distance 36 between the individual battery cells 10 connected to one another cohesively by the cross-connectors 34 embodied in strap-like fashion. Said distance can be just a few millimeters, thus to increase the packing density in a battery pack 12 which is generally allotted a plurality of battery cells 10 interconnected with one another in accordance with the interconnection scheme in FIG. 2.

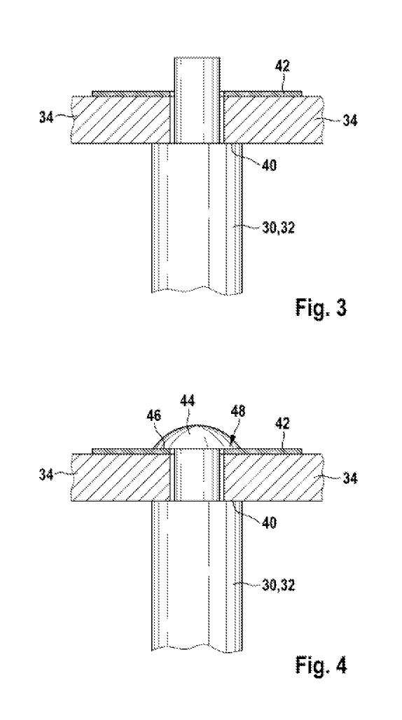

The illustration in accordance with FIG. 3 reveals a remelting of a contact pin of a battery cell.

In the embodiment variant in accordance with FIG. 3, the contact pin 30, 32 of the battery cell 10 (not illustrated) is produced from a material A, thus for example aluminum, and has a preferably round geometry. The contact pin 30, 32 comprises a diameter step 40 above which the contact pin 30, 32 tapers in its diameter in the axial direction. The tapered region of the contact pin 30, 32 projects into a correspondingly embodied opening in the cross-connector 34 embodied in strap-type fashion, said cross-connector being produced from the material B, thus for example copper. The material of the cross-connector 34 is provided, at a top side, cf. position 54, with a plating or a coating 42 produced from the material from which the contact pin 30, 32 is produced. In the embodiment variant illustrated in FIG. 3, the coating 42 is produced from the material A, i.e. from aluminum. The coating can also consist of a different material than the material A and/or the material B. The coating is to be produced such that it is suitable for combining with the remelting material. Nickel, silver and tin are advantageous alongside the basic materials Al and Cu used.

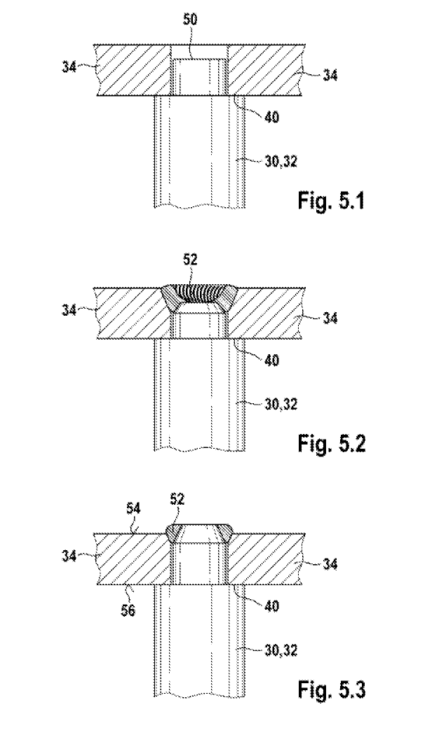

In the case of the method proposed according to the invention, the material of the contact pins 30 and 32 used is preferably that material of the materials A and B which has the lower melting point, in the present case material A, i.e. aluminum. The material having the higher melting point, in this case material B, i.e. copper, is generally chosen as the material from which the cross-connector 34 embodied in strap-type fashion is produced. It is evident from the illustration in accordance with FIG. 4 that the mass of the contact pin 30, 32 that remains in reduced diameter above the diameter step 40 has been remelted, thus establishing a contact zone 48 between the cross-connector 34 embodied in strap-type fashion, on the one hand, and an undercut 36 below a mushroom 44 of the contact pin 30 or 32. The remelting of the contact pin 30 or 32 produces an undercut 46 at which there arises a contact between the materials of the coating 42, i.e. in the present case of the material A, i.e. aluminum, and the material of the contact pin 30, 32 in the contact zone 48, i.e. likewise material A, i.e. aluminum. As a result of the cohesive connections proposed according to the invention and produced in association with FIGS. 3 and 4, very good contact resistances are achieved at the contact locations in comparison with the screw joints between the contact pins and the cross-connectors as described in FIG. 1.

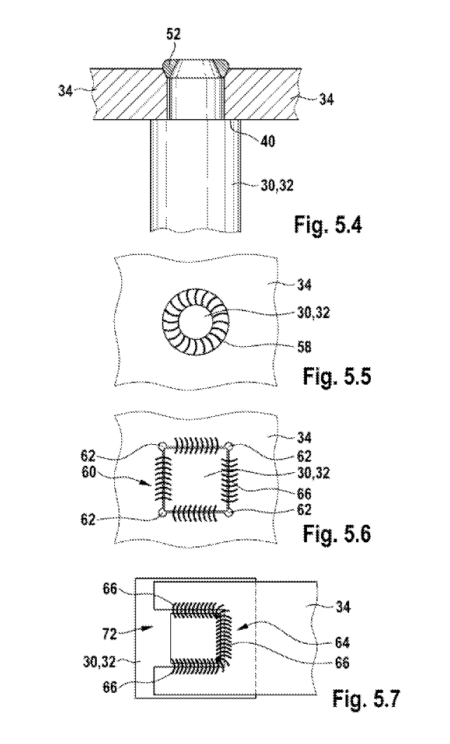

The illustration in accordance with FIG. 5.1 illustrates a countersinking of the contact pin 30, 32 in an opening in the cross-connector 34 embodied in strap-type fashion. In this embodiment variant, there is the possibility, given a shortening of the region extending in the axial direction with a reduced diameter above the diameter step 40, of countersinking the contact pin 30 or 32 in the opening in the cross-connector 34 embodied in strap-type fashion. Preferably, in the embodiment variant in accordance with FIG. 5.1, a coating is provided at the side surfaces of the opening in the cross-connector 34 embodied in strap-type fashion, said coating being produced from the material from which the contact pin 30 or 32 itself is produced, with the result that an identical material pairing is established in the region of the contact zone 48 illustrated in FIG. 4.

The illustrations in accordance with FIGS. 5.2 and 5.3 reveal cohesive connections between the cross-connector 34 embodied in strap-type fashion and the contact pin 30 or 32.

What is common to both circumferentially embodied cohesive connections 52 is that, in this embodiment variant of the cohesive joints proposed according to the invention, the basic material of the cross-connector 34 embodied in strap-type fashion is not melted or is only insignificantly incipiently melted. The formation of the cohesive connection itself in the context of the circumferentially embodied seam 52 is effected by melting the material of the contact pin 30, 32 onto the connector coating, i.e. onto the layer applied at the inner side of the opening in the cross-connector 34 embodied in strap-type fashion. As mentioned above, the material from which the contact pin 30 or 32 itself is produced is preferably chosen for this purpose.

In the case of the embodiment variants illustrated in FIGS. 5.3 and 5.3, a circumferential welding seam 52 is positioned, which constitutes the cohesive joint between the contact pin 30 or 32 and the cross-connector 34 embodied in strap-type fashion. In the embodiment variants in FIGS. 5.2 and 5.3, the material of the contact pin 30 or 32, thus for example aluminum, and the material of the cross-connector embodied in strap-type fashion, material B, for example copper, are melted. During the production of such a type-dissimilar combination of aluminum/copper, care should be taken to ensure that the mixing ratios of aluminum/copper in the melting bath yield an intermixing and no cracks or defects are established. A type-identical combination of the components to be joined together is advantageous in the case of this welding arrangement.

Geometry variations of the cohesive connection between the contact pin and the cross-connector embodied in strap-type fashion are revealed in greater detail in the illustrations in accordance with FIGS. 5.4 to 5.7.

FIG. 5.4 shows a circumferential cohesive connection embodied as a ring seam at the top side of the cross-connector 34 embodied in strap-type fashion, and FIG. 55 illustrates a continuously embodied ring seam 58 extending on the top side 54 of the cross-connector embodied in strap-type fashion. FIG. 5.6 shows a segmented seam 60 having a substantially square appearance, wherein in this case the contact pin 30 or 32 likewise has a square cross section. The segmented seam 60 comprises individual seam segments 66 which do not abut at corners 62 remaining free, rather each by itself constitutes a cohesive connection. The segmented seam 60 has the advantage that when cracks occur in the seam, thus for example owing to inadequate intermixing in the melting bath or in the case of other process disturbances, the cracks can lead only to the failure of one of the seam segments 62 and the remaining seam segments 66 are still available for current transmission and for ensuring strength.

The embodiment variant in accordance with FIG. 5.7 reveals a configuration of a segmented seam 60 which substantially has a U-shape and is formed between a contact pin 30, 32 which has a rectangular cross-sectional area and is joined to a cross-connector 34 embodied in strap-type fashion, said cross-connector having a slotted opening 72. The seam geometry formed in the illustration in accordance with FIG. 5.7 connects the material of the contact pin 30 or 32 at three abutting sides to the slotted opening geometry 72 of the strap-type cross-connector 34.

In the embodiment variants in FIGS. 5.4 to 5.7, the cross-connector 34 embodied in strap-type fashion can be produced both from the material A, i.e. aluminum, and from the material B, i.e. copper. The same applies to the contact pin 30 or 32, which can likewise be produced not only from the material A, i.e. aluminum, but also from the material B, i.e. copper, thus resulting in a type-dissimilar combination in the case of the outlined embodiment variants of a cohesive connection. Furthermore, it is unimportant whether the contact pin 30 or 32 has a round cross section or, as illustrated in association with FIGS. 5.6 and 5.7, an angular cross section.

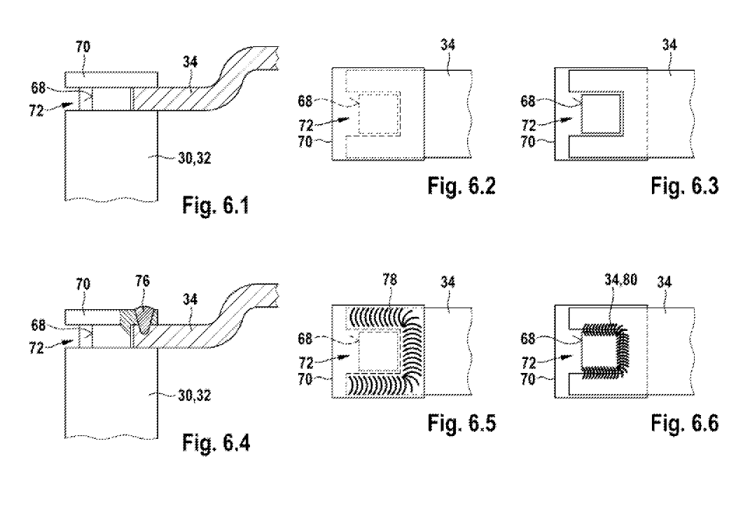

The figure sequence of FIGS. 6.1 to 6.3 shows an embodiment variant of a non-welded connection between the contact pin 30 or 32 and a strap-type cross-connector 34 embodied here in offset fashion. The strap-type cross-connector 34 comprises, for example, the slot geometry 72 of its opening, such that it is possible to compensate for length tolerances between adjacent battery cells 10 of a battery pack 12 to be produced. The connection embodied in unwelded fashion in FIGS. 6.1 to 6.3, and also the connection embodied in welded fashion, as illustrated in FIGS. 6.4 to 6.6, between the contact pin 30 or 32 and the strap-type cross-connector embodied substantially in offset fashion constitute an embodiment variant with respect to the hole described in the case of the above embodiment variants in FIGS. 3 to 5.5. In the case of the contact pin 30 or 32 in accordance with FIG. 6.1, a circumferential groove 68 is situated below a head-shaped covering 70, the slotted opening geometry 72 of the strap-type cross-connector 34 embodied in offset fashion projecting into said groove. FIG. 6.2 shows a view from below of the connection variant illustrated in FIG. 6.1, while the illustration in accordance with FIG. 6.3 represents a plan view of the unwelded connection in accordance with the illustration in FIG. 6.1.

In the case of the unwelded connections, as illustrated in FIGS. 6.1 to 6.3, between the cross-connector 34 embodied in strap-type fashion and the contact pin 30 or 32, there is also the possibility of a type-identical combination, i.e. an aluminum/aluminum connection, or a copper/copper connection, or a type-dissimilar connection, i.e. an aluminum/copper connection or a copper/aluminum connection.

FIGS. 6.4 to 6.6 show, in a development of the unwelded embodiment variants in accordance with FIGS. 6.1 to 6.3, that the connection for the compensation of length tolerances, as outlined above in association with FIGS. 6.1, 6.2 and 6.3, can also be embodied as a cohesive locking, i.e. as a cohesive connection. For this purpose, in accordance with FIG. 6.4, a spot weld 76 is provided, in the case of which the covering 70 is welded to the material of the cross-connector 34 embodied in offset and strap-type fashion, said material projecting into the circumferential groove 68. Instead of the spot weld 76 illustrated in FIG. 6.4, there is the possibility of implementing a segmented through-weld 78, in the case of which a segmented seam 60, as indicated in FIG. 5.6, is through-welded at only three sides, such that it is possible to achieve a cohesive connection which encloses the contact pin 30 or 32 but is not joined with the circumference of the tapered section of the contact pin 30 or 32.

FIG. 6.6 shows an abutting weld 80, in the case of which the cross-connector 34 is cohesively joined in three sides, in an abutting-similar manner to that in the embodiment variant in accordance with FIG. 5.7, to the side surfaces of the section—configured here in square fashion—of the contact pin 30 or 32 which has a smaller side length, compared with the rest of the material of the contact pin 30 or 32.

For the embodiment variants in FIGS. 6.4 to 6.6, too, it holds true that a type-identical or type-dissimilar combination of the materials aluminum/aluminum, copper/copper or a type-dissimilar material combination aluminum/copper or copper/aluminum can be implemented.

1. A method for producing an electrically conductive connection between a contact pin (30) or (32) and a cross-connector (34) at battery cells (10) comprising the following method steps:
a) producing the contact pin (30, 32) from a material A and producing the cross-connector (34) from a material B, which is different than material A, or
b) producing the contact pin (30, 32) from the material B and the cross-connector (34) from the material A,
c) producing an opening (35) in the cross-connector (34) and
d) producing a cohesive connection (52, 58, 60, 64, 76, 78, 80) between the contact pin (30, 32) and the cross-connector (34) by laser welding.

2. The method as claimed in claim 1, characterized in that the material A is an aluminum alloy, and in that the material B is copper or a copper alloy.

3. The method as claimed in claim 1, characterized in that the contact pin (30, 32) is preferably embodied with has a round geometry and is produced from the material the one of the materials A and B having a lower melting point.

4. The method as claimed in claim 1, characterized in that the cross-connector (34) is produced from that material the one of the materials A and B which is the material having the a higher melting point.

5. The method as claimed in claim 1, characterized in that the cross-connector (34) is provided with a coating (42) of that material the one of the materials A and B from which the contact pin (30) or (32) itself is produced.

6. The method as claimed in claim 1, characterized in that the opening (35) at the cross-connector (34) is provided with a coating (42) of that one of the materials A, B the one of the materials A and B from which the contact pin (30, 32) is produced.

7. The method as claimed in claim 1, characterized in that according to method step d) defined proportions by mass of the materials A, B are melted in the a melting bath, wherein the proportion by mass of Cu is from 0% to 53%, remainder aluminum, or the proportion by mass of Cu is from 91% to 100%, remainder aluminum.

8. The method as claimed in claim 1, characterized in that a remelting—fashioned in a mushroom shape (44)—of the cross-connector (34) is performed at a diameter step (40) of the contact pin (30) or (32).

9. The method as claimed in claim 1, characterized in that the cohesive connection according to method step d) is embodied as a ring seam (58) or as a segmented seam (60) or as a U-seam (64), as a spot-type through-weld (76) or as a segmented through-weld (78) or as an abutting weld (80).

10. The method as claimed in claim 9, characterized in that the spot-type through-weld (76) is produced between a flattened portion (70) of the contact pin (30) or (32) and a slotted opening (72) in the cross-connector (34).

11. The method as claimed in claim 9, characterized in that the segmented through-weld (78) is produced between individual seam segments (66) of the segmented seam (60) and a slotted opening (72) in the cross-connector (34) embodied in strap-type fashion.

12. The method as claimed in claim 9, characterized in that the abutting weld (80) is produced along a circumferential groove (68) of the contact pins (30) or (32) and a slotted opening (72) in the cross-connector (34) embodied in strap-type fashion.

13. An electrical contact-connection between a contact pin (30, 32) and a cross-connector (34), characterized in that the contact pin (30) or (32) is cohesively joined by laser welding to a cross-connector (34) embodied in strap-type fashion, said cross-connector having an opening (35) or a slotted opening geometry (72), wherein the cohesive connection (52) is embodied as a ring seam (58), as a segmented seam (60), as a U-seam (64), as a spot through-weld (76), as a segmented through-weld (78) or as an abutting weld (80) between the strap-type cross-connector (34) and the contact pin (30) or (32).
